(19) United States
(12) Patent Application Publication
(10) Pub. No.: US 2004/0156125 A1
(43) Pub. Date: Aug. 12, 2004

(54) Magnifying document holder

(76) Inventors: James B. Graham, McLean, VA (US); Justin D. Dudley, Oak Hill, VA (US)

Correspondence Address: ADAM J. CERMAK, LAW OFFICE OF ADAM J. CERMAK, P.O. BOX 7518, ALEXANDRIA, VA, 22307-7518, US

(21) Appl. No.: 10/770,402

(22) Filed: Feb. 4, 2004

Related U.S. Application Data
(60) Provisional application No. 60/444,660, filed on Feb. 4, 2003.

(51) Int. Cl. G02B 27/02

(52) U.S. Cl. 359/804

(57) ABSTRACT

A magnifying document holder includes a book-like holder in which a magnifying lens is attached by a hinge.

This application claims priority to U.S. provisional patent application No. 60/444,660, filed Feb. 4, 2003, for “Magnifying Invoice Holder”, by James Graham and Justin Dudley, the entirety of which is incorporated by reference herein.

### BACKGROUND OF THE INVENTION

1. Field of the Invention

The present invention relates to magnifying devices.

2. Brief Description of the Related Art

Magnifying lenses of numerous types have been available for many years, and have been useful for numerous tasks. With the increased use of advanced materials, magnifying lenses have been made thinner, lighter, more flexible, and less expensive.

Despite the wide use of such lenses, it is often inconvenient to carry a magnifying lens at all times. There thus remains a need for incorporation of such lenses into devices with which they can be used.

### SUMMARY OF THE INVENTION

According to a first aspect of the invention, a magnifying holder includes a front a back, a spine joining the front to the back, and a magnifying lens attached to the front or the back.

Still other objects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to preferred embodiments of the apparatus and method, given only by way of example, and with reference to the accompanying drawings, in which:

FIG. 1 illustrates a front perspective view of a device in accordance with a first embodiment of the present invention.

FIG. 2 illustrates an inside view of another device in accordance with a second embodiment of the present invention.

FIG. 3 illustrates a perspective view of a device in accordance with a yet another embodiment of the present invention.

FIGS. 4-7 illustrate inside views of further embodiments in accordance with the present invention

### DETAILED DESCRIPTION OF THE PREFERRED EMBODIMENTS

Referring to the drawing figures, like reference numerals designate identical or corresponding elements throughout the several figures.

In general terms, a magnifying document holder of the present invention includes two basic pieces: a traditional, single-hinged, folding holder or cover; and a transparent, magnifying optical lens.

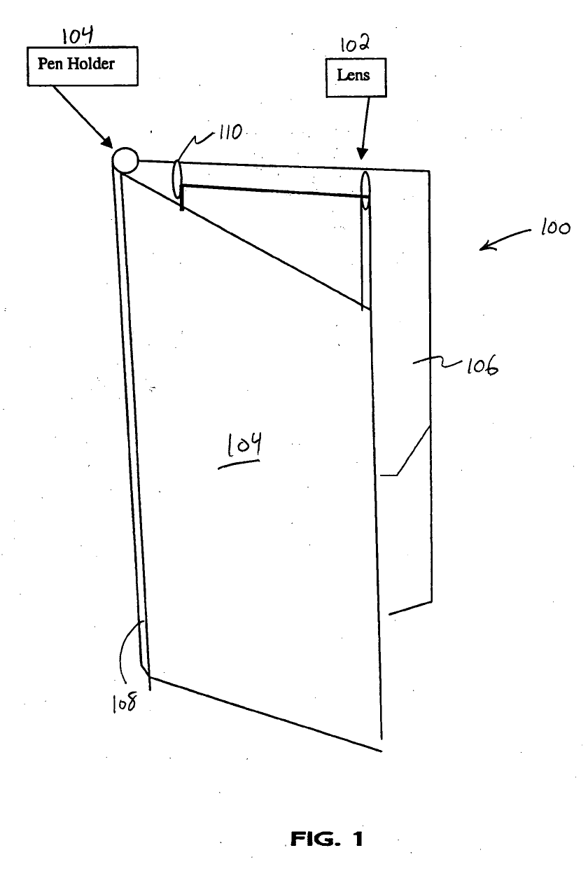

Turning now to the drawing figures, FIG. 1 illustrates a front perspective view of a first embodiment in accordance with the present invention. A holder 100 includes a back piece 106, which can be any size, preferably approximately 4″ wide and 9.5″ high. The back 106 can be made of any of numerous materials, including but not limited to leather or plastic, and is preferably about ⅛″ thick. A front piece 104 is substantially the same size and shape as the back 106, and the two pieces are bonded together along a hinge, spine, or bond 108. The hinge, spine, or bond 108 is preferably formed of a supple material, e.g., leather or vinyl, or other mechanism such as ring binders, spiral binding, comb binding, and the like, so that the holder 100 can be opened like a book or a folder. The front 104 and the back 106 are preferably aligned so that they meet evenly along every dimension. This design results in a light, attractive folder within which the user can hold one or more thin (e.g. paper) receipts, invoices, or similar documents. Additional features, such a pen holders 108, as are typically incorporated into such holders, may also be included within the scope of the present invention.

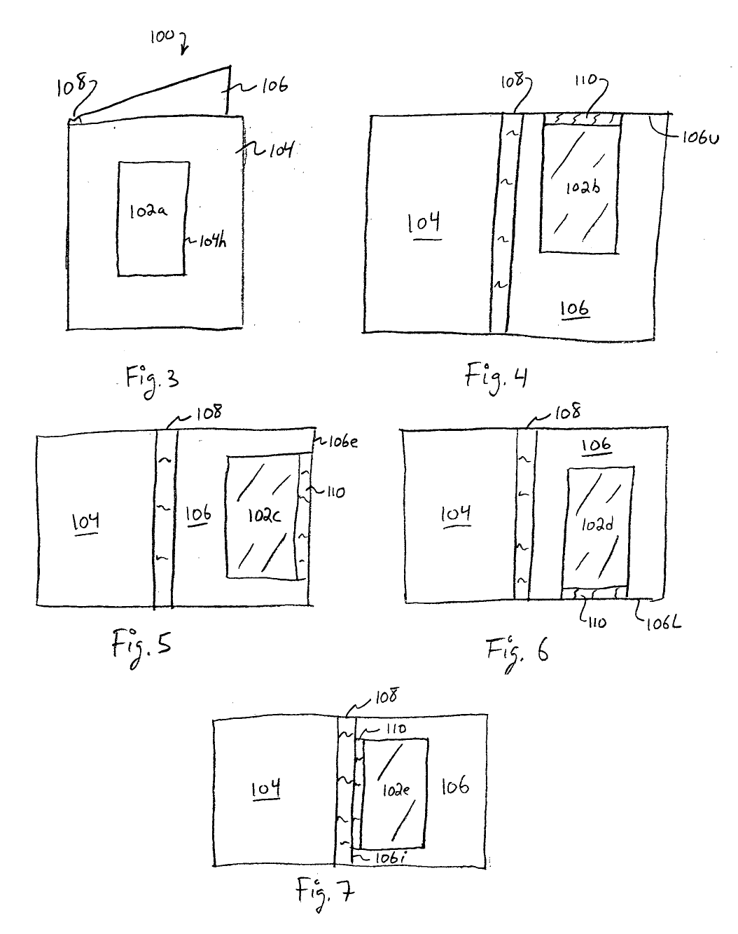

Integrated with the holder 100 is a magnifying lens 102. The lens 102 is preferably rectangular, and more preferably is approximately 3″ wide and 5″ high. The lens 102 is attached to the holder 100 so that the lens can be moved relative to at least one of the front 104 and the back 106, so that a user can utilize the magnifying optics of the lens to assist in reading a document. As illustrated in FIG. 1, the lens 102 is attached to the inside of the back 106 along the top or upper edge back, where the top would be recognized as the upper edge of the cover if the user was holding it vertically along its longer dimension (see also FIG. 4). In the embodiment illustrated in FIGS. 1 and 4, the lens 102, 102b is positioned inside the holder 100 when the holder is closed, but becomes visible to the user when the holder is opened, and is attached to an upper edge 106u of the back 106.

The lens 102 is preferably attached to the holder using a hinge 110, e.g., supple material, e.g. leather, cloth, or vinyl, so that the lens can be lifted up from an unattached end of the lens, or folded down to lay flat on the back 106 prior to closing the holder. The material attaching the lens 102 to the back 106 provides a separation, preferably about ½ inch of separation, between the back 106 and the connected edge of the lens 102, allowing the user to lift the connected end of the lens slightly above the back of the holder. In this configuration the user can lift the lens up from its unattached dimension and hold it above any receipt, invoice, or document that had been inserted into the holder so that the user's view of such document is magnified.

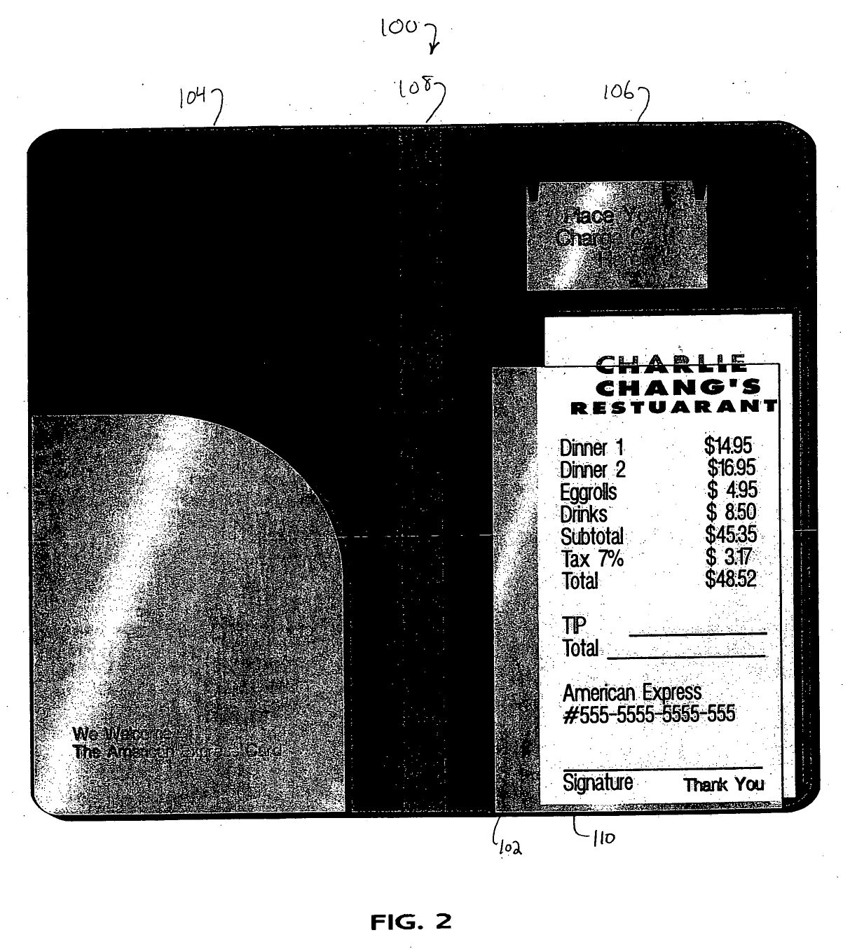

FIG. 2 illustrates an inside view of another embodiment of a holder in accordance with the present invention. The embodiment illustrated in FIG. 2 is substantially similar to that illustrated in FIG. 1, with the exception that the lens 102 is attached via hinge 110 to a lower edge of the back 106. As can be seen in FIG. 2, the lens 102 can be used to magnify a document placed adjacent to the lens.

FIG. 3 illustrates a front perspective view of yet another embodiment of a holder 100 in accordance with the present invention. The embodiment illustrated in FIG. 3 is similar in many respects to the other embodiments described herein. In FIG. 3, the lens 102a is positioned, preferably centered, within and attached to or built into the front 104 of the holder. By way of example, the front 104 includes a hole 104h cut out of the front with dimensions generally matching those of the lens 102. The lens 102 is inserted into the hole and affixed to the front 104, preferably along all dimensions of the lens, with an appropriate adhesive, tape, or the like. In FIG. 3, the hinge 108 connecting the front 104 to the back 106 is made to be slightly wider than in the embodiments described above, such that the front and back are held slightly apart. This additional space allows the user to lift the front 104 away from the back 106 slightly along the hinged dimension. In the embodiment illustrated in FIG. 3, the user can look through the lens 102 and see anything held inside the cover where the lens would magnify the user's view of those things inside the cover.

Turning now to FIGS. 5-7, additional exemplary embodiments of holders 100 are illustrated. In FIGS. 5-7, the lens 102c, 102d, 102e, is attached, via hinge 110 to an outer side edge 106e, a lower side edge 106l, and an inner portion 106i, respectively, of the back 106, at the short or long edge of the lens, as illustrated in the figures. Preferably, the lens is centered on each edge. In each of FIGS. 5-7, the lens is inside the holder 100 when the holder is closed, but becomes visible to the user when the holder is opened. The hinge 110 attaching the lens 102 to the back 106 provides a separation, preferably about ¼″ of separation, between the back and the connected edge of the lens, allowing the user to lift the connected end of the lens slightly above the back if necessary.

The present invention is not restricted to a holder including a magnifying lens, but extends to other applications beyond a restaurant invoice presentation device, and there are additionally embodiments that combine a vision-assistance lens with everyday products. The following list provides non-limiting examples of products that are integrated with a magnifying lens or magnifying mirror in accordance with the present invention: wallets, menu portfolios (holds a restaurant menu), pocket calendars, brief cases, computer cases, portable computer lids, personal digital assistant carrying cases, purses, makeup bags, contact lens cases, glasses cases, checkbook covers, Bible, hymnbook cover, grocery carts, sports programs, car sun visors, airplane and train ticket portfolios, passport portfolios, cookbook holders, credit cards (e.g., built into the plastic card), hat and cap visors, pen caps, office products, salt and pepper shakers, lids for coffee cups, crossword puzzle portfolios, dictionary and other book covers, calculators, watches, telephones receivers, cell phones, golf carts, clipboards, scorebooks, coffee mugs, place mats, Bridge scoring pads, playing cards, mouse pads, CD and tape plastic holders, doctors utensils such as stethoscopes, prescription pads, and “black bag”, scrub cap for nurses and doctors, TV and VCR remote controls, TV schedule or guide holder, magazine holder, map holder, fishing tackle box, golf bag, cigarette lighter, cigarette package holder, camera bags, and VCR bags.

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in its entirety.

What is claimed is:

1. A magnifying holder comprising:
a front;
a back;
a spine joining the front to the back; and
a magnifying lens attached to the front or the back.

2. A holder in accordance with claim 1, wherein the front includes a hole therethrough, and the lens is attached to the front and over the hole.

3. A holder in accordance with claim 1, further comprising:
a lens hinge attached between the lens and the back.

4. A holder in accordance with claim 3, wherein the lens hinge comprises a supple material.

5. A holder in accordance with claim 3, wherein the back includes a first edge and a second edge, the first edge being longer than the second edge, the lens hinge attached to the long edge.

6. A holder in accordance with claim 5, wherein the long edge is opposite the spine.

7. A holder in accordance with claim 5, wherein the long edge is adjacent the spine.

8. A holder in accordance with claim 3, wherein the back includes a first edge and a second edge, the first edge being longer than the second edge, the lens hinge attached to the short edge.

9. A holder in accordance with claim 1, wherein the back is substantially rectangular and includes a first edge and a second edge, the first edge being about 9.5 inches long, and the second edge being about 4 inches long.

10. A holder in accordance with claim 1, wherein the lens is substantially rectangular and includes a first edge and a second edge, the lens first edge being about 3 inches long and the second edge being about 5 inches long.
